(19) United States
(12) Patent Application Publication
(10) Pub. No.: US 2017/0180313 A1
(43) Pub. Date: Jun. 22, 2017

(54) Associating Geolocation Data With IP Addresses

(71) Applicant: Blis Media Limited, London (GB)

(72) Inventors: Gregor Donald ISBISTER, London (GB); Davide ANASTASIA, London (GB); Elena YEGOROVA, Greenhithe (GB); Guy NEEDHAM, London (GB)

(21) Appl. No.: 15/451,911

(22) Filed: Mar. 7, 2017

Related U.S. Application Data
(63) Continuation-in-part of application No. 15/336,023, filed on Oct. 27, 2016.
Application No. 15/336,023 is a continuation of application No. 13/857,338, filed on Apr. 5, 2013, now abandoned.

(30) Foreign Application Priority Data
Apr. 5, 2012 (GB) 12 06 254.3

(51) Int. Cl. H04L 29/12; H04L 12/26; H04L 29/08

(52) U.S. Cl. CPC H04L 61/609; H04L 61/2007; H04L 67/10; H04L 43/08

(57) ABSTRACT

Methods associating geolocation data received via an Internet Protocol (IP) network with IP addresses are disclosed. A plurality of advertisement requests are received from a plurality of publishers connected to the IP network. Each advertisement request comprises an IP address and geolocation data comprising the latitude and longitude of a device requesting a resource from the publisher. A first table is constructed having records indexed by IP address and values that are the geolocation data of each advertisement request. Cluster analysis is then carried out on the records to identify clusters of records that have the same IP address and geolocation data that meet a density threshold. A centroid for each cluster and a confidence level for the centroid are then evaluated. The IP addresses, the latitude and longitude of the centroid and the confidence level of each cluster are then written to a second table.

### CROSS REFERENCE TO RELATED APPLICATIONS

This application is a continuation-in-part of U.S. application Ser. No. ______ filed ______ (Attorney Docket No. 4113-P102-US-2), which is a continuation of U.S. application Ser. No. 13/857,338 filed Apr. 5, 2013 (now abandoned), and which claim priority from United Kingdom Patent App. No. 12 06 254.3 filed Apr. 5, 2012, now United Kingdom Patent No. 2 500 936. The whole contents of each of the above-identified applications are incorporated herein by reference in their entirety.

### BACKGROUND OF THE INVENTION

1. Field of the Invention

This invention relates to associating geolocation data received via an Internet Protocol (IP) network with IP addresses.

2. Description of the Related Art

Location-based services are becoming increasingly commonplace methodologies for delivering content to users, particular those who use mobile devices. In particular, publishers (also known as content providers) commonly wish to provide users with more relevant content in view of their current location—examples of such content being bespoke, dynamically-generated copy specific to a particular location, and advertising. For instance, a publisher may produce regional or even city-based news stories, and may wish to know a user's present location such that they are presented with relevant news. Advertising may need to be presented on a location-specific basis—it would be no good, say, for a user browsing a web page in a first city to be presented with advertising for events occurring in a second city.

Whilst many mobile devices are now location-aware, which is to say they have Global Positioning System (GPS) or similar functionality, and can therefore generate geolocation data, only a small fraction actually give up this data to third parties.

It is therefore desirable to take measures to associate geolocation data with other data that is always provided by mobile devices.

### BRIEF SUMMARY OF THE INVENTION

The present invention is directed towards associating geolocation data received via an Internet Protocol (IP) network with IP addresses. The method of the present invention comprises receiving a plurality of advertisement requests via the IP network, each one of which is received from a respective one of a plurality of publishers connected to the IP network. Each of the plurality of advertisement requests comprises an IP address and geolocation data comprising the latitude and longitude of a device requesting a resource from the publisher over the IP network.

A map procedure is performed on the plurality of advertisement requests to construct a first table having records indexed by IP address and values that are the geolocation data of each advertisement request.

A reduce procedure is performed on the first table that includes (i) carrying out cluster analysis on the records to identify clusters of records that have the same IP address and geolocation data that meet a density threshold, (ii) for each cluster of records that is identified, evaluating a centroid of the geolocation data of each record in the cluster, and evaluating a confidence level that the centroid has that latitude and longitude, and (iii) writing the IP addresses, the latitude and longitude of the centroid and the confidence level of each cluster to a second table.

### BRIEF DESCRIPTION OF THE DRAWINGS

FIG. 1 shows an environment in which the present invention can be used;

FIG. 2 is an illustration of the scarcity of requests from browsing clients that contain geolocation data;

FIG. 3 shows a Real Time Bidding (RTB) environment;

FIG. 4 shows an example of an apparatus for implementing the present invention;

FIG. 5 shows procedures carried out by the RTB computer 401;

FIG. 6 shows the software components used to implement step 505;

FIG. 7 shows procedures carried out by the reducer 603;

FIG. 8 shows the locations derived from requests having a particular IP address;

FIG. 9 shows steps carried out to find clusters analysis at step 701;

FIG. 10 shows steps carried out to perform the cluster analysis of step 904;

FIG. 11 shows steps carried out in step 701 to determine centroids of clusters;

FIG. 12 shows steps carried out in step 703 to evaluate confidence scores;

FIG. 13 shows centroids for an IP address at different times;

FIG. 14 shows the weighting of confidence scores; and

FIG. 15 shows steps carried out to evaluate an overall confidence score for the location of an IP address.

### DETAILED DESCRIPTION OF EXAMPLE EMBODIMENTS

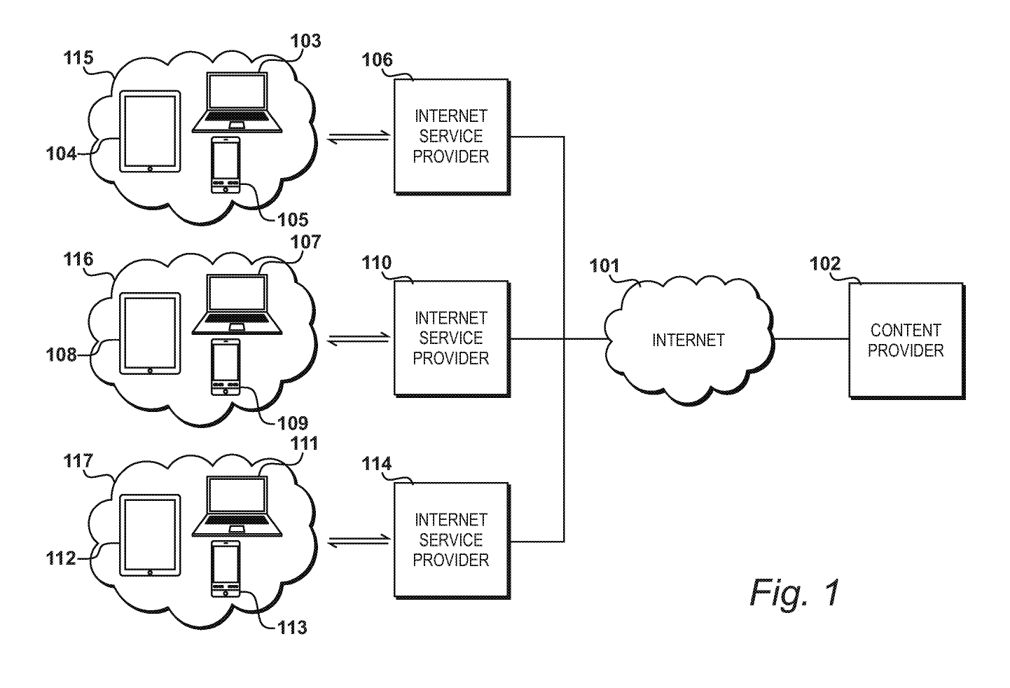

FIG. 1

An exemplary environment in which the present invention may be used is illustrated in FIG. 1.

Connected by an Internet Protocol (IP) network such as the Internet 101, are a publisher 102, which provides web content such as web pages, videos and images, and a number of client devices. Each client device, in this case, is connected via an internet service provider (ISP) using wireless networking technologies, such as 802.11b/g. Thus, client devices 103, 104 and 105 are connected to the Internet 101 by means of ISP 106; client devices 107, 108 and 109 are connected to the Internet 101 by means of ISP 110; and client devices 111, 112 and 113 are connected to the Internet 101 by means of ISP 114. In this example, each of ISPs 106, 110 and 114 provides Internet access to connected client devices at a particular location. Thus, client devices 103, 104 and 105 may be connecting to ISP 106 at a hotel, for instance. This type of service is commonly referred to as a “wireless hotspot”, and thus creates wireless hotspots 115, 116 and 117, with ISPs offering Internet access to client devices so as to allow web browsing, email access and so on. In this example, ISP 106 provides Internet access to client devices at a location distinct from ISP 110, ISP 110 provides Internet access to client devices at a location distinct from ISP 114, and so on.

There has recently become a demand for location-aware content. For instance, users may wish to receive content that is only relevant to them in their present location. Furthermore, publishers themselves may only wish to provide particular content to client devices at particular locations. A further need for location-aware generation of content exists in terms of not providing content to users in particular locations, thus allowing a greater degree of control over the distribution of content.

The present invention has a particular aim in the sort of scenario illustrated in FIG. 1: to enable more fine-grained provision of location-specific content to more users.

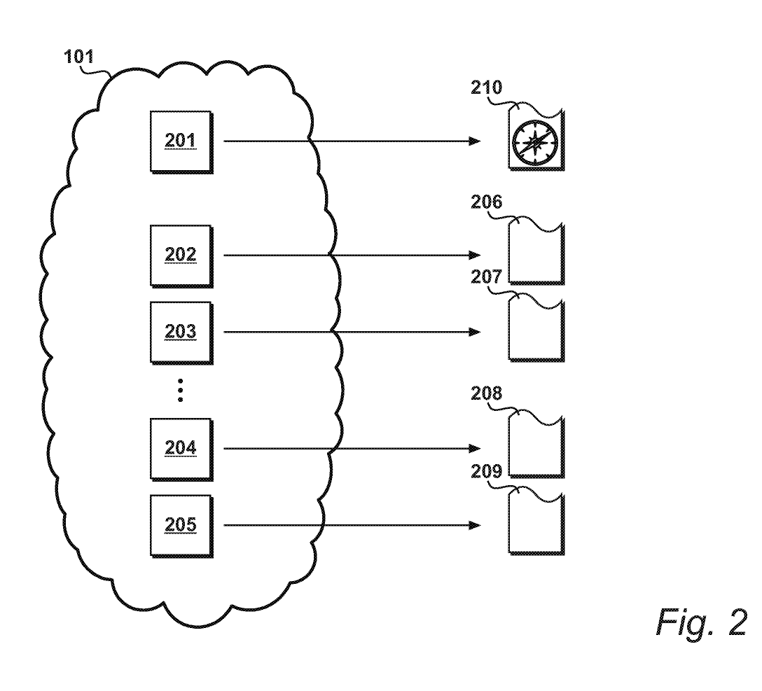

FIG. 2

As will be appreciated by those skilled in the art, not all client devices have functionality that allows the provision, to a publisher, of their present location. FIG. 2 illustrates this problem diagrammatically.

A number of devices 201, 202, 203, 204 and 205 form part of the Internet 101, each possibly being connected to a wireless hotspot, such as those described previously with respect to FIG. 1. Each one of these devices sends out requests whenever they require data of some form—for example, they may be requesting an initial webpage HTML document using HTTP, or may, having received that HTML document, be requesting further resources required to display the webpage correctly, such as images, video or advertising.

Most of these requests, such as request 206 issued by device 202, request 207 issued by device 203, request 208 issued by device 204, and request 209 issued by device 205, contain only information concerning the Internet-facing IP address of the client device, the device type, the browser type and so forth. However, (as found in research conducted by the present applicant), in around five percent of cases, requests may include geolocation data, such as request 210 issued by device 201. Device 201 can therefore be characterised as a locatable browsing client. In many cases, this geolocation data comprises latitude and longitude co-ordinates generated by GPS-based technology present in the device. Other geolocation data that can be provided includes orientation (provided by a magnetometer or a compass) and altitude (either provided by GPS or an altimeter).

Thus, at first sight, it may seem, therefore, that only five percent of requests can be responded to with content that is sympathetic to a device's location.

However, the present applicant has recognised that in the case of ISP-owned wireless hotspot, such as those operated in the context of FIG. 1 by ISPs 106, 110 and 114, location-aware content can be provided to any and all client devices. Each wireless hotspot, such as wireless hotspots 115, 116 and 117, utilises some form of router to allow its connected client devices to access the Internet 101. Such routers often utilise Network Address Translation, such that devices connected on the local area network side of the router, whilst each having a distinct Internet Protocol (IP) address, appear from the wide area network side of the router to have the same IP address—the IP address of the router. Thus, referring to FIG. 1, it is clear from this knowledge that each one of the devices 103, 104 and 105 that are connected to ISP 106 will, from the perspective of publisher 102, appear to have the distinct originating IP address of the router operating the wireless hotspot operated by ISP 106. As the router is practically guaranteed to remain in a particular location, it is possible to therefore associate a particular location with a particular IP address, irrespective if the requests from the client devices themselves actually include geolocation data.

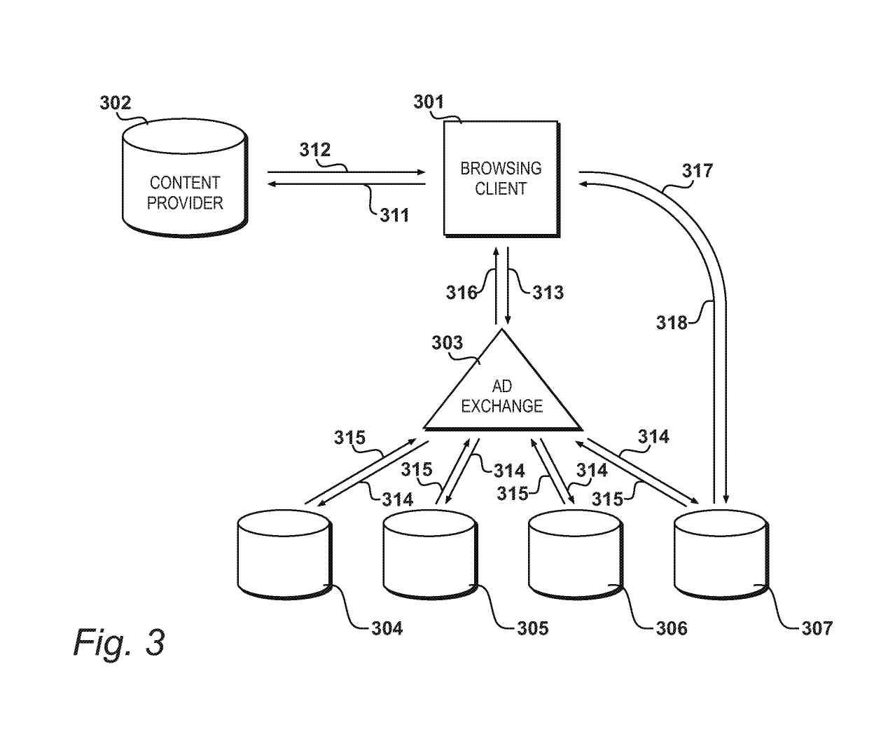

FIG. 3

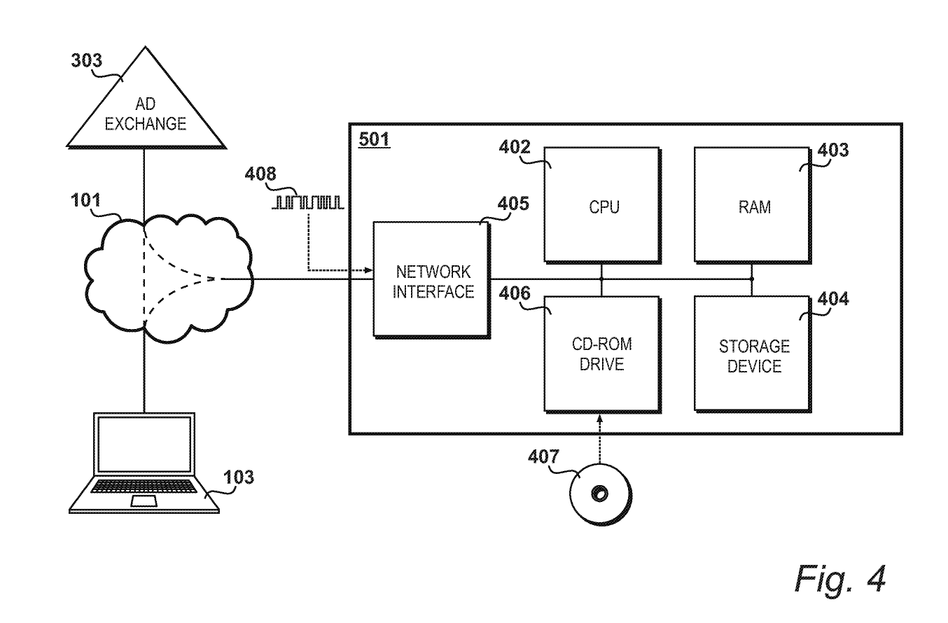

In the present embodiment, this is achieved by operating a computer within a Real Time Bidding environment for advertising, as shown in FIG. 3. The constituent components of such a computer will be expanded upon with reference to FIG. 4.

As will be appreciated by those skilled in the art, Real Time Bidding is a method of selling and purchasing advertising for display on a web page or within an application. This selling and purchasing is done in real time, and on a per-impression basis. Referring to FIG. 3, the way in which this operates will now be described.

A browsing client 301 makes a request at 311 for some content, such as a web page, from a publisher 302. The publisher supplies the HTML (or similar) for the web page to the browsing client at 312. Included in the code of the web page, is a pointer (known in the art as an “ad tag”) to resource hosted by an advertising exchange 303. Thus, at 313, the browsing client makes an advertisement request to the advertising exchange for the resource—i.e. the image or video to show as part of an advertisement on the web page. Importantly, this advertisement request to the advertising exchange includes data concerning the identity of the client and the publisher, and, as described previously with reference to FIG. 2, in a small proportion of cases this includes geolocation data.

After receiving this request, the advertising exchange 303 forwards the advertising requests at 314 to each one of a number of participants in the Real Time Bidding Environment—namely participants 304, 305, 306 and 307. This allows the participants to make an informed choice on the potential value of the advertising impression they are about to bid on. Each participant thus makes a decision as to whether to bid on the opportunity to present their advertising to the browsing client, and return their responses at 315. In this example, participant 307 wins the auction, and so advertising exchange 303 returns to browsing client 301 at 316 the location of a resource hosted by participant 307. At 317, browsing client 301 requests the resource (i.e. the data constituting an advertisement) from participant 307, which serves the data to the browsing client at 318.

FIG. 4

Illustrated in FIG. 4 is an example of a computer apparatus that can be used by a participant in the Real Time Bidding environment described previously with reference to FIG. 3.

Thus, in this second embodiment, the apparatus is adapted to operate as a Real Time Bidding (RTB) computer 401. Upon receiving an advertising request from advertising exchange 303, appropriate bids on the advertising impression can be made by RTB computer 401.

In order for RTB computer 401 to execute instructions, it comprises a processor such as central processing unit (CPU) 402. In this instance, CPU 402 is a single multi-core Intel® Xeon® processor. It is possible that in other configurations several such CPUs will be present to provide a high degree of parallelism in the execution of instructions.

Memory is provided by eight gigabytes of DDR3 random access memory (RAM) 403, which allows storage of frequently-used instructions and data structures by RTB computer 401. A portion of RAM 403 is reserved as shared memory, which allows high speed inter-process communication between applications running on RTB computer 401.

Permanent storage is provided by a storage device such as hard disk drive 404, which in this instance has a capacity of one terabyte. Hard disk drive 404 stores operating system and application data. In alternative embodiments, a number of hard disk drives could be provided and configured as a RAID array to improve data access times, and the hard disk drive could be substituted with a solid-state disk.

A network interface 405 allows RTB computer 401 to connect to the Internet 101, possibly via an internal network and a router (not shown), and provide advertising content to a browsing client, such as client device 103 previously referenced with respect to FIG. 1, and also to receive advertising requests from advertising exchange 303. It will be appreciated that some of these advertising requests, as explained with reference to FIG. 2 and FIG. 3, will include geolocation data in addition to just the browsing client's IP address and identity of the publisher, etc. Network interface 405 also allows an administrator to interact with and configure web server 401 via another computer using a protocol such as secure shell.

RTB computer 401 also comprises an optical drive, such as a CD-ROM drive 406, into which an optical disk, such as a CD-ROM 407 can be inserted. CD-ROM 407 comprises computer-readable instructions that are installed on hard disk drive 404, loaded into RAM 403 and executed by CPU 402. Alternatively, the instructions (illustrated as 408) may be transferred from a network location using network interface 405. The instructions, when executed by the RTB computer 401, cause it to carry out the methods of the present invention.

It is to be appreciated that the above system is merely an example of a configuration of system that can fulfil the role of RTB computer 401. Any other system having a processor, memory, and a network interface could equally be used. Indeed, RTB computer 401 could be deployed as a virtual appliance on a virtualization platform hypervisor.

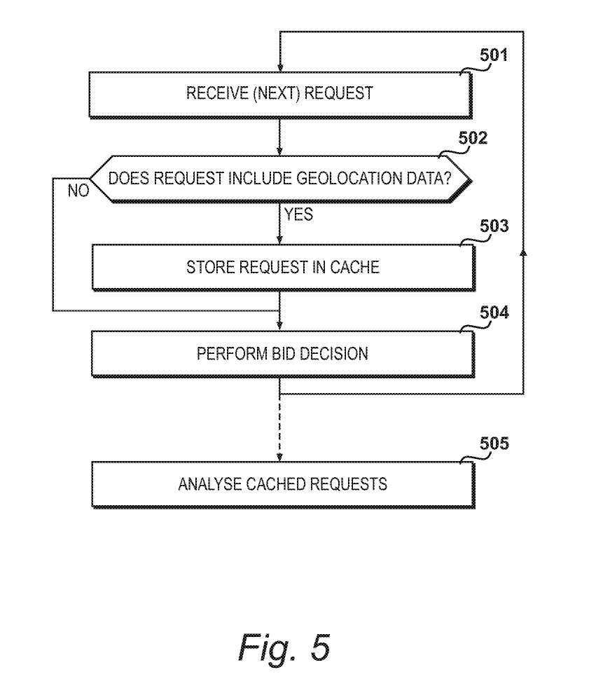

FIG. 5

As described previously, the present invention is directed towards correlating geolocation data received from publishers with IP addresses. Procedures carried out by RTB computer 501, following the loading of instructions onto them, are illustrated in FIG. 5. These particular procedures allow this correlation to be performed.

At step 501, an advertising request is received, identifying the publisher, a unique identifier for the device, and geolocation data for the device, i.e. its latitude and longitude co-ordinates.

At step 502, a question is asked as to whether the advertising request received at step 501 did comprise geolocation data. If so, then at step 503 the request is stored on the hard disk 404 in a cache.

At step 504, a bid decision is made in the known manner, and the process repeats itself until, on a periodic basis, an analysis step 505 is performed on the cached advertising requests. In the present embodiment, analysis step 505 is carried out once a day, but alternatively could be carried out more frequently or more infrequently.

In the context of RTB computer 401, the request received will be the data concerning the browsing client from an advertising exchange, which may include geolocation data as previously described.

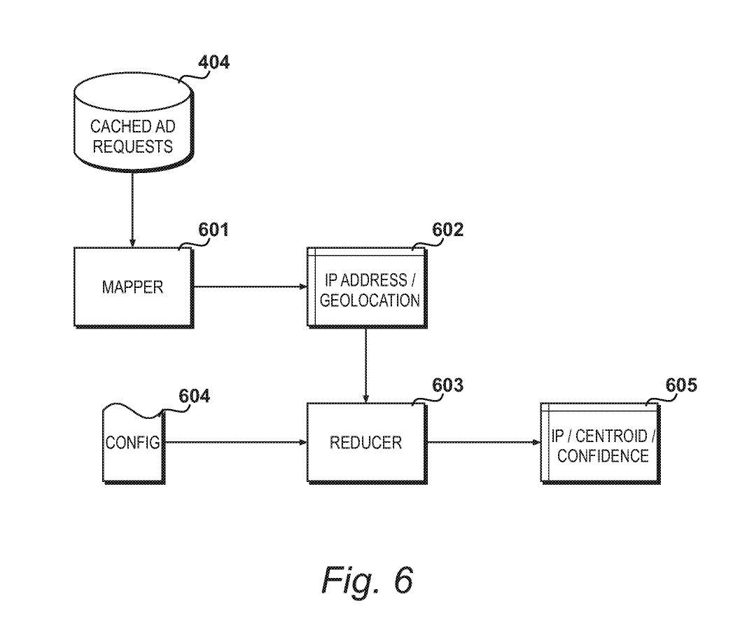

FIG. 6

A block diagram of the software components used in the analysis step 505 is shown in FIG. 6.

The cached advertisement requests stored during step 503 are supplied from the hard disk drive 404 to a mapper 601. The mapper 601 runs on the CPU 402 is configured to perform a map procedure that parses the advertisement requests to produce a table 602, which is stored in RAM 403.

The table 602 is indexed by the IP addresses from the advertisement requests, and in the present embodiment has values that are at least the corresponding geolocation data (i.e. the latitude and longitude) from that advertisement request.

In the present embodiment, the cached advertisement requests have been subjected to a filtering operation to ensure that they contain valid geolocation data. This is achieved by applying the method disclosed in Applicant's co-pending U.S. application Ser. No. ______ filed ______ (Attorney Docket No. 4113-P105-US), the whole contents of which are incorporated herein by reference.

The table 602 parsed out of the cached advertisement requests is then supplied to a reducer 603. The reducer 603 is operative to perform a reduce procedure that involves reading the table 602, and performing, inter alia, cluster analysis on the values in it. The procedures carried out by the reducer 603 utilise various parameters which are stored in a configuration file 604. These parameters will be described further within the context of the description of the procedures carried out by the reducer.

The results of the analyses are stored in another table 605 which is indexed by IP addresses, and has values comprising the latitude and longitude of the centroid of the IP address and a confidence level that an IP address has a particular latitude and longitude.

It will be noted by those skilled in the art that the “mapper” and “reducer” components may be subsumed in the MapReduce framework for making the processing of the large dataset achievable in a short period. Thus, in an embodiment the function of the reducer 603 is carried out by distributed processing system in parallel.

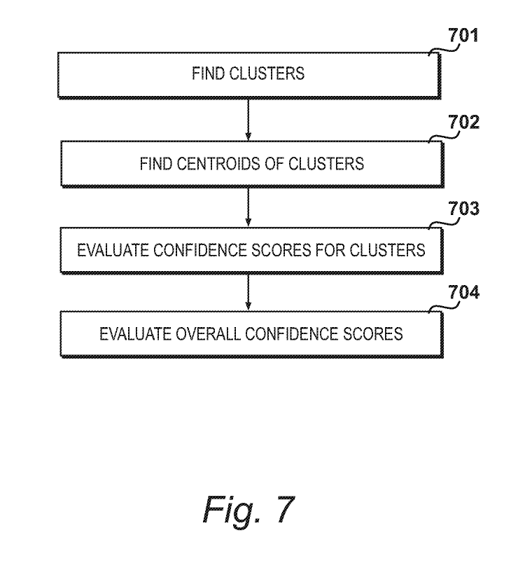

FIG. 7

An overview of procedures carried out by the reducer 603 is shown in FIG. 7.

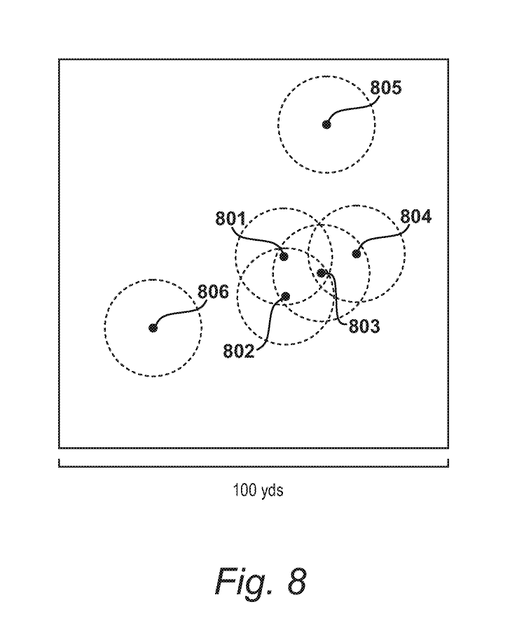

Initially, the reducer 603 performs a step 701 comprising finding clusters in the table 602 on the basis of the geolocation data recorded therein. This process will be described further with reference to FIGS. 8, 9 and 10.

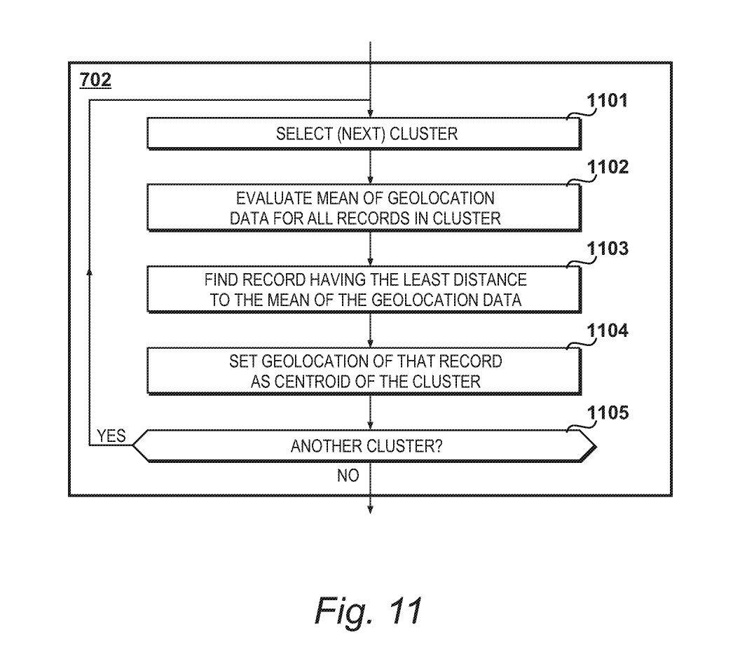

Following the identification of clusters, at step 702 the reducer 603 proceeds to find the centroids of the clusters it found at step 701. This process will be described further with reference to FIG. 11.

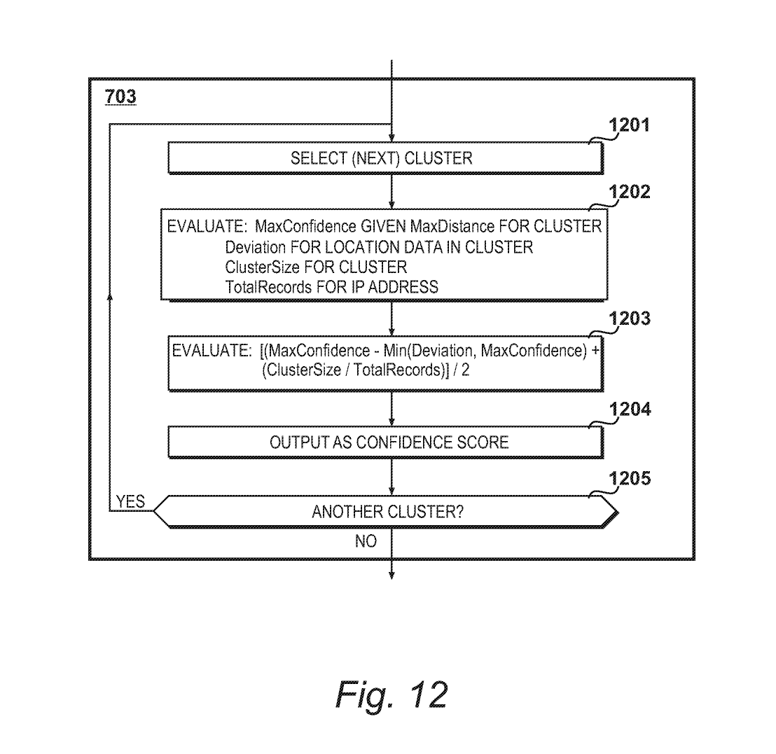

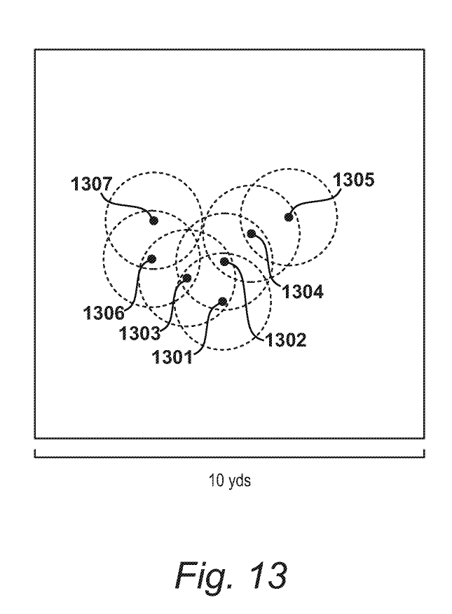

After the centroids of the clusters have been evaluated, the reducer 603 proceeds to step 703 where confidence scores for the clusters are evaluated. This process will be described further with reference to FIG. 12. Finally, step 704 is performed in which an overall confidence score is evaluated, taking into account the contemporaneous result of step 703 along with the results of historic executions. Step 704 will be described further with reference to FIGS. 13, 14 and 15.

FIG. 8

As described previously, the reducer 603 performs cluster analysis to identify clusters of geolocation data having the same IP addresses. As will be familiar to those skilled in the art, cluster analysis groups objects in the same group (called a cluster) that are more similar (in some sense or another) to each other than to those in other groups.

In the present embodiment, density-based clustering is used in which clusters are defined as areas of higher density than the remainder of the data set of table 602.

The density-based clustering used by the present invention is based on what is termed “density-reachability” and “density-connectedness”. A set of points are illustrated in FIG. 8 so as to allow the meaning of these terms to be described.

As shown in the Figure, a set of points 801 to 806 are distributed in a 100 square-yard area. The points 801 to 806 correspond to records in table 602 that each have the same IP address, but different geolocation data. The task undertaken by step 701 is to discern whether the points signify a location at which, to a good degree of certainty, it can be assumed that any incoming request having the same IP address as the records to which points 801 to 806 correspond, shares the same location.

Step 701 firstly identifies whether or not a minimum number of points (MinPoints) are within a distance (MaxDistance) of a point under consideration. The two parameters MinPoints and MaxDistance used by the reducer 603 in step 701 are defined in the configuration file 604.

In the present example, MinPoints is set to 2, and MaxDistance is set to 10 yards. Such points are density-reachable from each other. Thus, in the present example, considering point 801, points 802 and 803 are density-reachable as they are all within 10 yards of each other, as illustrated by the dashed lines surround each point.

The clustering process therefore considers points 801 to 803 as the basis for a cluster 807, as there are two points within MaxDistance of point 801, and then carries out a further step to identify other points that may be in the cluster 807. This involves, in this example, for each one of points 801 to 803, identifying points which are within MaxDistance of the point under consideration. Thus, no other points are within MaxDistance of points 801 and 802, however, when point 803 is considered, it is found that point 804 is within MaxDistance of it. Point 804 is density-connected to the other points in the cluster 807, without being density-reachable from all of the other points in the cluster 807.

Points 805 and 806 are not part of the cluster 807, as they are not within MaxDistance of any of points 801 to 804.

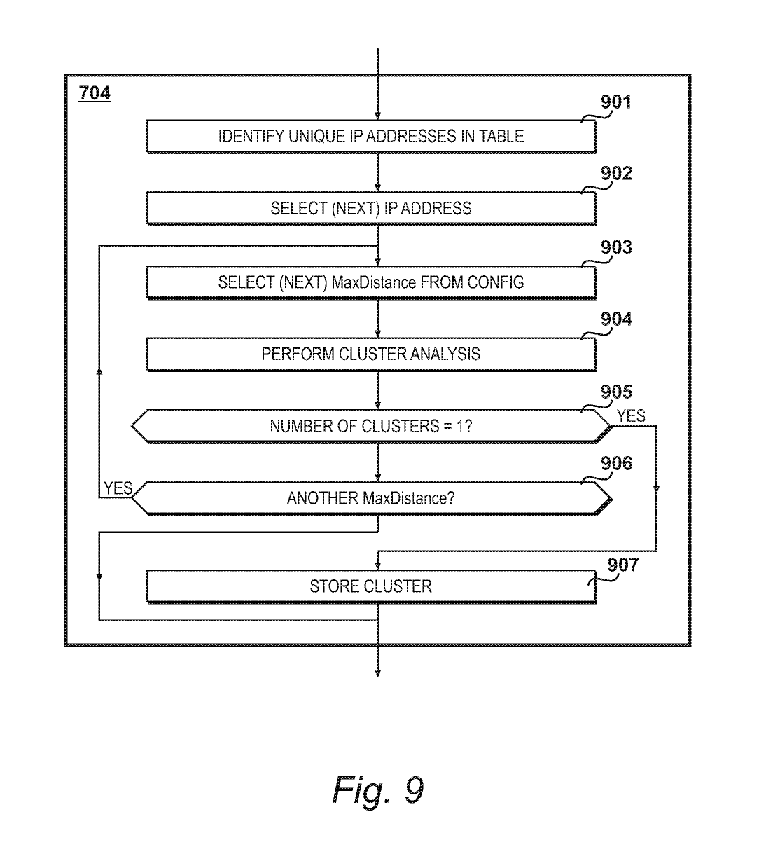

FIG. 9

The method of finding clusters at step 701 is set out in FIG. 9.

First, the reducer 603 reads all of the records in table 602 at step 901 to identify each unique IP address therein. At step 902, an IP address is selected for processing, forming record set comprising all of the records in table 602 with that IP address.

A processing loop is then initiated in the present embodiment, in which clustering may be performed for a plurality of values of MaxDistance defined in the configuration file 604. In the present embodiment, the configuration file 604 includes an array defining specific values for MaxDistance to utilise. Presently, the values are 5 yards, 10 yards, 15 yards, 20 yards, and 25 yards. However, it will be understood that the provision of the configuration file 604 allows these values to be altered, and also increased or decreased in number. Thus, it is contemplated that in an alternative embodiment there may be only one MaxDistance defined for a particularly strict approach to identifying clusters. Alternatively, many more values for MaxDistance may be provided, and may not have a linear relationship. The difference between the values may instead be non-linear, following a power law for example.

At step 903 therefore, an initial value for MaxDistance is obtained from the configuration file 604. Cluster analysis using the record set formed at step 902 and using the current value of MaxDistance is then performed at step 904.

A question is then asked at step 905 as to whether the number of output clusters is equal to 1. If so, then a 1:1 mapping between an IP address and a location has been identified and the cluster is then stored at step 907, along with the particular MaxDistance value that resulted in the formation of the cluster. Step 701 is then completed.

If the question asked at step 905 was answered in the negative, then one of two scenarios has occurred: either no clusters were found, or two or more were found. In the latter case, the aforesaid 1:1 mapping is not possible and thus no link can be made between the IP address and a particular location. Thus a question is then asked at step 906 as to whether there is another MaxDistance to utilise. If so, control returns to step 903 where it is selected and the loop continues until either a single cluster is identified, or all MaxDistance values have been looped through with no single cluster being output at step 904.

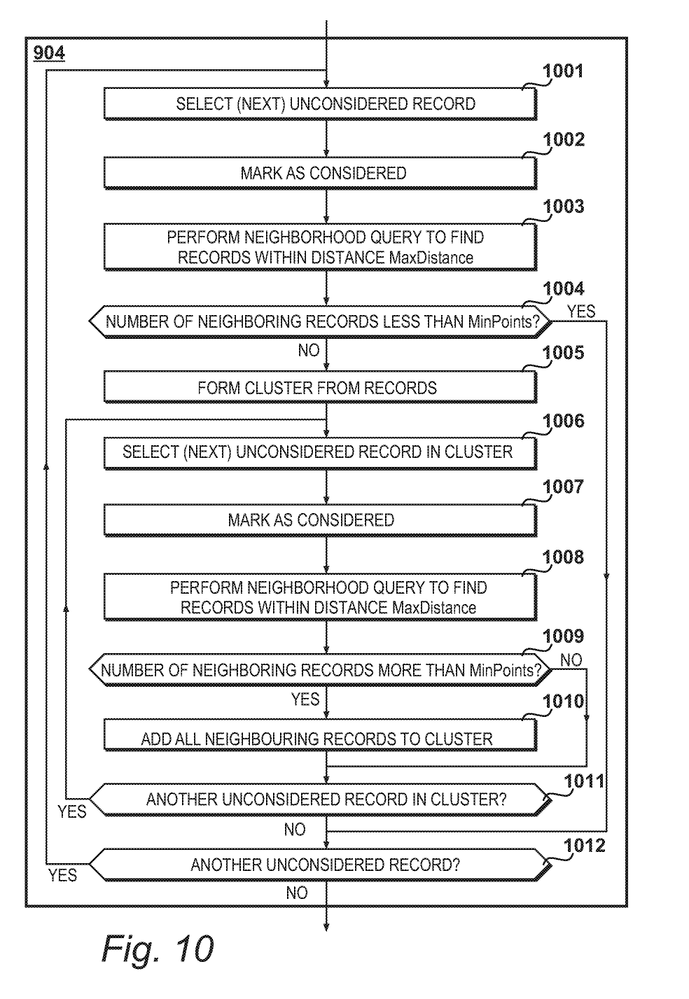

FIG. 10

The method of performing the cluster analysis in step 904 is shown in FIG. 10, which is invoked on a per-IP address basis, and as previously described may be repeated to attempt to identify a single cluster for an IP address.

Thus given a record set comprising records from table 602 having a particular IP address, the reducer 603 initially selects an unconsidered record at step 1001. This record is then marked as considered at step 1002, and then at step 1003 performs a neighbourhood query to find at least MinPoints other records that are mutually within MaxDistance of each other. This is achieved with reference to latitude and longitude co-ordinates supplied in the geolocation data in table 602. The neighbourhood query implements a fixed-radius nearest neighbour search of the table 602, and may use any of the known algorithms for performing such a task such as a linear search or more optimised algorithms that utilise GPUs for example.

A question is then asked at step 1004 as to whether the number of neighboring points identified in step 1003 was less than MinPoints. If not, a cluster is formed at step 1005, consisting of the record selected in step 1001, and the at least MinPoints records identified in step 1003. These are the density-reachable records for the cluster.

In the example illustrated in FIG. 8, steps 1001 to 1005 would result in a cluster being formed from points 801 to 803.

Referring again to FIG. 10, control then proceeds to step 1006 where a process of looping through each record in the newly-formed cluster begins. Note that in steps 1006 to 1011 the terms “considered” and “unconsidered” are distinct from those same terms used outside the loop, i.e. in steps 1001 to 1005 and 1012.

Thus an unconsidered record in terms of the cluster is selected at step 1006, with that record being marked as considered for the purposes of the loop from steps 1006 to 1011. At step 1008, a neighbourhood query is again performed to find any records that are within MaxDistance of the point selected in step 1006. At step 1009, a question is asked as to whether the number of points identified in step 1008 is greater than or equal to MinPoints. If so, then at step 1010, all points identified at step 1008 are added to the overall cluster (avoiding duplication). The records added over and above those produced by steps 1001 to 1005 are the density-connected records for the cluster.

Then, or if the question asked at step 1009 was answered in the negative, a question is asked at step 1011 as to whether there are any more unconsidered records in the cluster. If so, then control returns to step 1006, until all records in the cluster have been marked considered by step 1007, whereupon a question is asked at step 1012 as to whether there are any further unconsidered records to consider. If so, control returns to step 1001. When all records having a particular IP address have been considered, then step 701 is complete.

With reference to the example given in FIG. 8, steps 1006 to 1011 would not result any records being added to the cluster when performed in respect of points 801 and 802. However, when performed on point 803, each of points 801, 802 and 804 are discovered to be within MaxDistance of point 803. This therefore results in point 804 being added to the cluster.

FIG. 11

After clusters have been identified in table 602, a decision must be taken as to what latitude and longitude to be ascribed to it for eventual output to table 605 by the reducer 603. Procedures carried out in step 702 are therefore detailed in FIG. 11.

A cluster produced during step 701 is selected at step 1101, and the mean of the geolocation data of all of the records in the cluster is evaluated at step 1102. At step 1103, the record in the cluster having the least distance to the mean is identified, and is then stored at step 1104 as the centroid for the cluster. This is so that the centroid for the cluster is a location that is actually capable of being visited in reality.

A question is then asked at step 1105 as to whether another cluster needs to be considered, and if so, then control returns to step 1101 until all clusters have been considered and step 702 is finished.

FIG. 12

The reducer 603 then proceeds to perform step 703, which is detailed in FIG. 12.

Step 703 iterates over all of the clusters found in step 701, and thus at step 1201, one of the clusters is selected for processing.

At step 1202, several variables are evaluated, namely the variables MaxConfidence, Deviation, ClusterSize and TotalRecords.

The MaxConfidence for a cluster takes into account the particular MaxDistance used during the process of finding clusters at step 701, and the smallest MaxDistance (“MinMaxDistance”) defined in the configuration file 604. The value of MaxConfidence is defined such that when MaxDistance is at its smallest, the MaxConfidence is 1, and, for a factor of 10 increase in MaxDistance, the MaxConfidence halves. This relationship can be expressed as follows:

MaxConfidence=2^{-log}^{₁₀}^{MaxDistance/MinMaxDistance} [Equation 1]

Thus, if the smallest MaxDistance defined in the configuration file 604 was 1 yard, then MaxConfidence when MaxDistance was 1 yard would be 1, and when MaxDistance was 10 yards, then MaxConfidence would be 0.5. If the smallest MaxDistance defined in the configuration file 604 was 5 yards, then MaxConfidence when MaxDistance was 5 yards would be 1, and when MaxDistance was 50 yards, then MaxConfidence would be 0.5

The Deviation for the geolocation data in the cluster is in the present example the standard deviation for the geolocation data.

ClusterSize is an integer which is a count of the number of records in the selected cluster.

TotalRecords is the total number of records in table 602 having the IP address of the records in the selected cluster, irrespective of whether they formed part of the particular cluster under consideration.

The values evaluated in step 1202 are then used at step 1203 to begin a calculation of the confidence score. An evaluation is made as to the difference between MaxConfidence, and the smaller of Deviation and MaxConfidence. Thus, this value can never be negative. This is then summed with the ratio of ClusterSize and TotalRecords. The resulting value is finally halved, and then at step 1205 is output as the confidence score for the cluster.

A question is then asked as to whether there are any further clusters to consider, and if so then control returns to step 1201, until eventually the confidence scores for all of the clusters found in step 701 have been outputted into memory for the final analysis at step 704.

FIG. 13

As described previously, in the present example clusters are given a confidence score, which is a measure of the confidence that an IP address has an actual location. A single confidence score on a particular set of records obtained over a short period as with step 703 could be evaluated, but in the present example a further step is taken so that it is possible to state that a high confidence is given to locations for which an IP address has been static (in terms of location) for a long period of time.

Thus, in the present example, step 703 for evaluating the confidence scores of the clusters found in step 701 utilises a number of historic clusters found in previous iterations of step 701. In the example described herein, the analysis step 505 runs daily, and step 703 utilises the current day and six previous days' worth of cluster data. It is possible to use more data, and two weeks' worth is also envisaged as a suitable time frame.

Thus in FIG. 13, a week's worth of centroids produced by step 702 for a particular IP address are illustrated. Centroids 1301 through 1307 are shown being within around 5 yards of each other.

The requirement to be confident in the long term presence of an IP address at a particular location means that the present invention again utilises cluster analysis to ensure that there is a sufficiently strong relation between the centroids to be confident that any variation in location is not significant.

Thus, as illustrated in FIG. 13, centroids 1301 to 1303 are within a MaxDistance of 1 yard of each other. With MinPoints set again at 2, this will result in the formation of a cluster of density-reachable points. Consideration of each of centroids 1301 to 1303 to identify density-connected points results in the addition of centroids 1304 to 1307 to the cluster. By forming a cluster, there is a high likelihood that the IP address is static in terms of its location and there is not a significant degree of movement thereof.

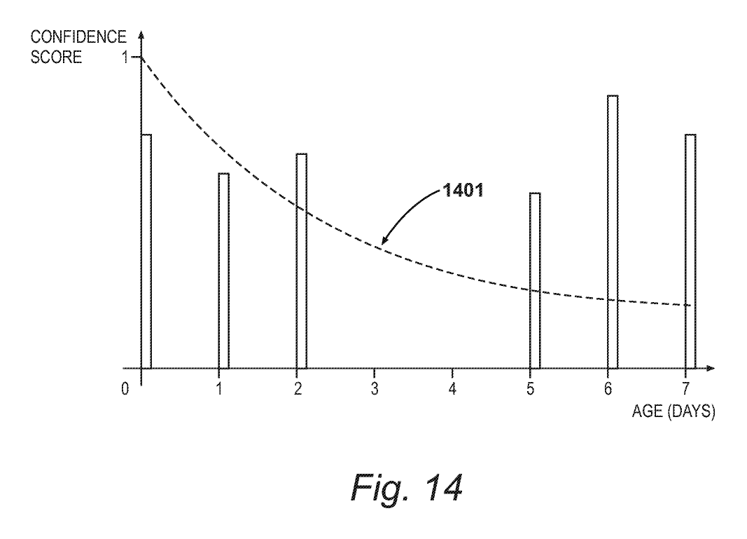

FIG. 14

One reason in particular to evaluate a long-term confidence score is shown in FIG. 14, which is a plot of confidence score against the age of the cluster for which the score was calculated.

The confidence score for the current day, the previous day, two days previous, five days previous, six days previous and seven days previous are non-zero, but as can be seen the confidence score on three and four days previous is zero. This could be because the particular location corresponding to the IP address was closed to visitors on that day, e.g. the location is an office closed at a weekend. No records having the IP address would therefore be found, and no clusters would be created. This does not mean that the IP address is no longer there. However, if only the confidence score for a single day were taken into account, then there would be zero confidence in the IP address existing and so opportunities to, for example, re-target content to devices known to have visited the particular location could be missed.

Thus in an embodiment of the present invention, historic confidence scores are combined with a current confidence score (produced in step 703) to solve this problem.

The confidence scores are averaged, and in the present embodiment a weighting function is used such that older confidence scores contribute less to the overall confidence score for a particular location. In this specific example, an inverse exponential weighting function 1401 is used, whereby the inverse of the age of the confidence score is the exponent.

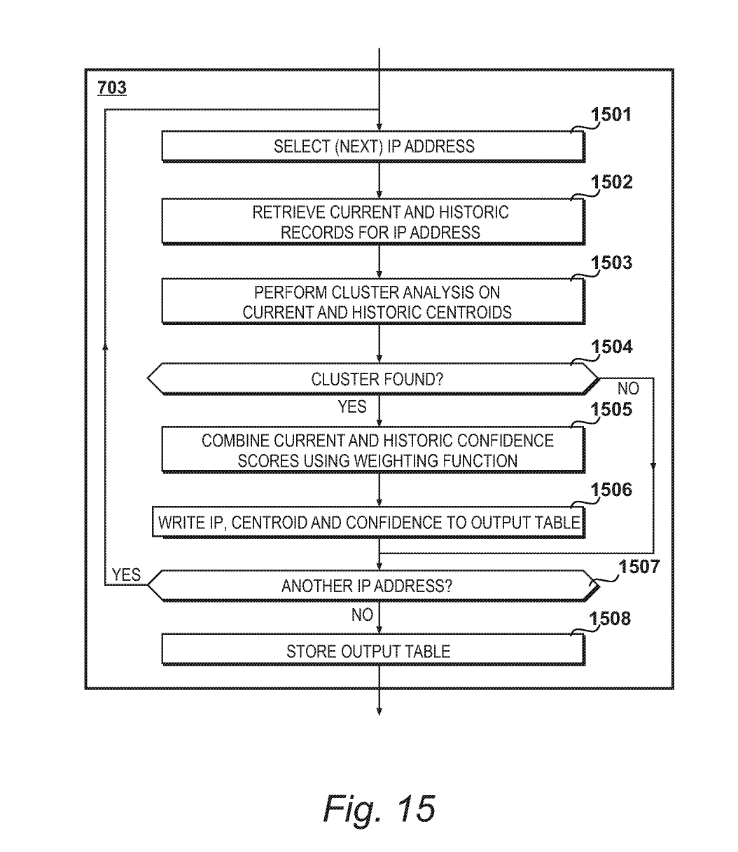

FIG. 15

Procedures carried out in step 704 to produce the overall confidence score for an IP address using current and historic confidence scores are set out in FIG. 15.

The procedures set out in the Figure are performed for each distinct IP address identified as a result of the current execution of step 701 and the historic ones retrieved from memory. Thus at step 1501, an IP address is selected and at step 1502 the current and historic confidence scores are obtained.

At step 1503, cluster analysis is performed as described previously with reference to FIG. 13 using substantially the procedure shown in FIG. 10 to ascertain whether there is a sufficient relationship between the centroids to be confident that an IP address has remained substantially in the same location for long enough. This cluster analysis is substantially the same as that carried out in step 701, but as described previously MaxDistance and MinPoints may be altered depending upon the degree of certainty required.

A question is asked at step 1504 as to whether a cluster has been found, and if so, then the current and historic confidence scores are combined according to the weighting function 1401 at step 1505. The IP address, newest centroid and confidence are then written to the output table 605 at step 1506.

Then, or if the question asked at step 1504 was answered in the negative, a question is then asked at step 1507 as to whether there are any other IP addresses to consider. If so, control returns to step 1501 until eventually all have been considered and steps 1501 to 1507 are complete. The output table is then finally committed to disk by the reducer 603 at step 1510.

The result is a table that allows content to be served to devices on the basis of only the IP address in requests originating from them, and allows more accurate decisions to be made on the content to be served given the geolocation data and confidence therein stored in output table 605.

1. A method comprising associating geolocation data received via an Internet Protocol (IP) network with IP addresses, the method comprising:
receiving a plurality of advertisement requests via the IP network, each one of which is received from a respective one of a plurality of publishers connected to the IP network, and wherein each of the plurality of advertisement requests comprises an IP address and geolocation data comprising the latitude and longitude of a device requesting a resource from the publisher over the IP network;
performing a map procedure on the plurality of advertisement requests to construct a first table having records indexed by IP address and values that are the geolocation data of each advertisement request; and
performing a reduce procedure on the first table that includes (i) carrying out cluster analysis on the records to identify clusters of records that have the same IP address and geolocation data that meet a density threshold, (ii) for each cluster of records that is identified, evaluating a centroid of the geolocation data of each record in the cluster, and evaluating a confidence level that the centroid has that latitude and longitude, and (iii) writing the IP addresses, the latitude and longitude of the centroid and the confidence level of each cluster to a second table.

2. The method of claim 1, in which the cluster analysis to identify clusters of records that have the same IP address and geolocation data that meet a density threshold comprises the iterative steps of:
selecting an IP address that has not yet been considered (a selected IP address);
selecting a record having the selected IP address in the first table that has not yet been considered (a selected record);
identifying all records having the selected IP address that are density-reachable from the selected record in terms of their geolocation data by being within a maximum radius of the selected record (density-reachable records);
if the number of density-reachable records exceeds a threshold number, identifying all records having the selected IP address that are density-connected to the selected record in terms of their geolocation data (density-connected records);
setting the selected record, the density-reachable records and the density-connected records as part of a cluster, and as having been considered.

3. The method of claim 2, in which, for each unique IP address in the first table, said iterative steps are repeated with a larger maximum radius unless only one cluster is found.

4. The method of claim 3, in which said iterative steps are repeated a plurality of times, each time with a larger maximum radius than a previous iteration.

5. The method of claim 2, in which a record is density-connected to the selected record if it is density-reachable in terms of its geolocation data from one of the density-reachable records.

6. The method of claim 1, in which the centroid of each cluster is evaluated by, for each cluster:
evaluating the mean of the geolocation data of each record in the cluster; and
identifying the record in the cluster having geolocation data with a latitude and longitude that is the minimum distance to said mean, and setting its geolocation data as the latitude and longitude of said centroid.

7. The method of claim 2, in which the confidence level is evaluated, for each cluster, by taking into account the maximum radius for records to be considered density-reachable, the deviation in the geolocation data in the records in the cluster, and the ratio of the number of records in the cluster to the total number of records in the first table with the same IP address.

8. The method of claim 7, in which the evaluation of the confidence level further comprises, for each cluster,
setting cluster as a current cluster, such that the confidence level is a current confidence level and the latitude and longitude of the centroid of the current cluster is current latitude and longitude of the centroid of the current cluster;
retrieving a plurality of historic clusters corresponding to the same IP address as the cluster, which historic clusters define historic latitude and longitude of the centroid of the cluster;
performing a cluster analysis on the current and historic clusters;
if a cluster is found, combining the current and historic confidence values using a weighting function to output a weighted confidence level
storing the weighted confidence level as the confidence level for the current cluster.

9. The method of claim 8, in which the weighting function causes historic confidence values to contribute in inverse proportion to their age.

10. The method of claim 8, in which the weighting function is an inverse exponential function in which the exponent comprises the age of the historic cluster.

11. A non-transitory computer-readable medium having computer-readable instructions encoded thereon, in which said computer-readable instructions, when executed by a computer, cause the computer to perform a method comprising associating geolocation data received via an Internet Protocol (IP) network with IP addresses, the method comprising:
receiving a plurality of advertisement requests via the IP network, each one of which is received from a respective one of a plurality of publishers connected to the IP network, and wherein each of the plurality of advertisement requests comprises an IP address and geolocation data comprising the latitude and longitude of a device requesting a resource from the publisher over the IP network;
performing a map procedure on the plurality of advertisement requests to construct a first table having records indexed by IP address and values that are the geolocation data of each advertisement request; and
performing a reduce procedure on the first table that includes (i) carrying out cluster analysis on the records to identify clusters of records that have the same IP address and geolocation data that meet a density threshold, (ii) for each cluster of records that is identified, evaluating a centroid of the geolocation data of each record in the cluster, and evaluating a confidence level that the centroid has that latitude and longitude, and (iii) writing the IP addresses, the latitude and longitude of the centroid and the confidence level of each cluster to a second table.

12. The non-transitory computer-readable medium of claim 11, in which the cluster analysis to identify clusters of records that have the same IP address and geolocation data that meet a density threshold comprises the iterative steps of:
selecting a record in the first table that has not yet been considered (a selected record);
identifying all records that are density-reachable from the selected record in terms of their geolocation data by being within a maximum radius of the selected record (density-reachable records);
if the number of density-reachable records exceeds a threshold number, identifying all records that are density-connected to the selected record in terms of their geolocation data (density-connected records);
setting the selected record, the density-reachable records and the density-connected records as part of a cluster, and as having been considered.

13. The non-transitory computer-readable medium of claim 12, in which, for each unique IP address in the first table, said iterative steps are repeated with a larger maximum radius unless only one cluster is found.

14. The non-transitory computer-readable medium of claim 13, in which said iterative steps are repeated a plurality of times, each time with a larger maximum radius than a previous iteration.

15. The non-transitory computer-readable medium of claim 13, in which a record is density-connected to the selected record if it is density-reachable in terms of its geolocation data from one of the density-reachable records.

16. The non-transitory computer-readable medium of claim 12, in which the centroid of each cluster is evaluated by, for each cluster:
evaluating the mean of the geolocation data of each record in the cluster; and
identifying the record in the cluster having geolocation data with a latitude and longitude that is the minimum distance to said mean, and setting its geolocation data as the latitude and longitude of said centroid.

17. The non-transitory computer-readable medium of claim 13, in which the confidence level is evaluated, for each cluster, by taking into account the maximum radius for records to be considered density-reachable, the deviation in the geolocation data in the records in the cluster, and the ratio of the number of records in the cluster to the total number of records in the first table with the same IP address.

18. The non-transitory computer-readable medium of claim 17, in which the evaluation of the confidence level further comprises, for each cluster:
setting cluster as a current cluster, such that the confidence level is a current confidence level and the latitude and longitude of the centroid of the current cluster is current latitude and longitude of the centroid of the current cluster;
retrieving a plurality of historic clusters corresponding to the same IP address as the cluster, which historic clusters define historic latitude and longitude of the centroid of the cluster;
performing a cluster analysis on the current and historic clusters;
if a cluster is found, combining the current and historic confidence values using a weighting function to output a weighted confidence level
storing the weighted confidence level as the confidence level for the current cluster.

19. The non-transitory computer-readable medium of claim 18, in which the weighting function causes historic confidence values to contribute in inverse proportion to their age.

20. The non-transitory computer-readable medium of claim 18, in which the weighting function is an inverse exponential function in which the exponent comprises the age of the historic cluster.
